(19) United States
(12) Patent Application Publication
(10) Pub. No.: US 2004/0230784 A1
(43) Pub. Date: Nov. 18, 2004

(54) Concurrent program loading and execution

(76) Inventor: Eugene M. Cohen, Eagle, ID (US)

Correspondence Address: HEWLETT-PACKARD DEVELOPMENT COPANY, Intellectual Property Administration, P.O. Box 272400, Fort Collins, CO, 80527-2400, US

(21) Appl. No.: 10/436,727

(22) Filed: May 12, 2003

(51) Int. Cl. G06F 15/177

(52) U.S. Cl. 713/1

(57) ABSTRACT

Systems and methods for concurrently loading and executing a computer program allow for beginning execution of a computer program while the computer program is being loaded into a primary memory for access by a processor.

### TECHNICAL FIELD

The technical field of the systems and methods described herein relates to computer program loading and executing.

### BACKGROUND

In various computing systems a Direct Memory Access (DMA) controller is used to load a computer program from a data storage device into Random Access Memory (RAM) for execution by a microprocessor. As is typical, the execution of the computer program by the microprocessor does not commence until the DMA controller has finished loading the program into RAM. Unfortunately, the loading of the computer program into RAM by the DMA controller may take a significant amount of time. As such, the microprocessor can be left idle while the DMA controller loads the program into RAM, thus losing valuable processing time.

### SUMMARY

Described herein are implementations of various systems and methods for concurrently loading and executing a computer program. More particularly, the various systems and methods described herein relate to beginning execution of a computer program from a memory while the computer program is being loaded into the memory.

### BRIEF DESCRIPTION OF THE DRAWINGS

FIG. 1 is a block diagram illustrating various components of a computing system for concurrently loading and executing computer programs in accordance with one embodiment.

FIG. 2 illustrates operations for concurrently loading and executing a computer program in accordance with one embodiment.

FIG. 3 illustrates operations for handling invalid instructions while concurrently loading and executing a computer program in accordance with one embodiment.

FIG. 4 illustrates other operations for handling invalid instructions while concurrently loading and executing a computer program in accordance with one embodiment.

### DETAILED DESCRIPTION

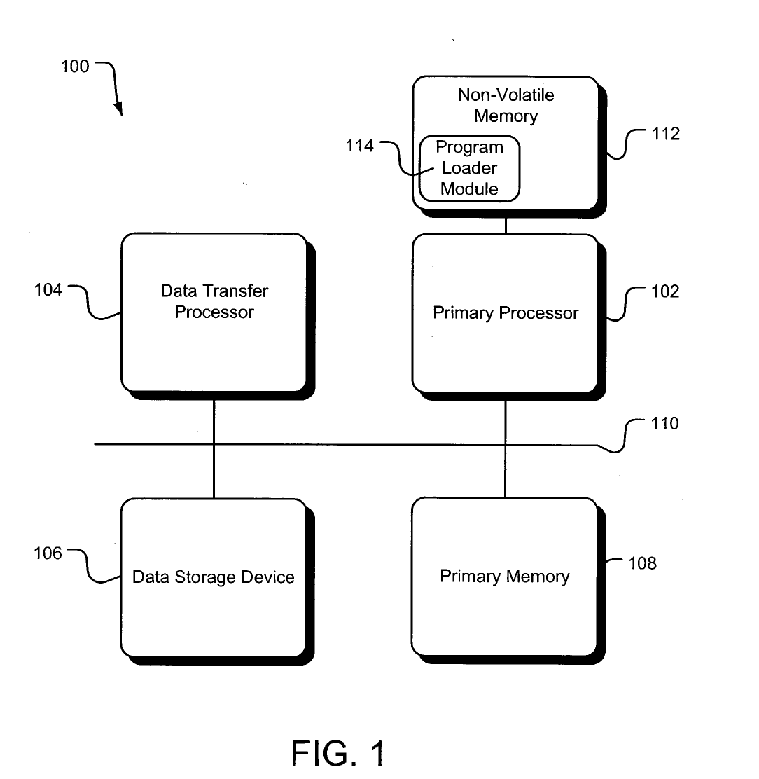

FIG. 1 illustrates an exemplary implementation of a computing system 100 for concurrently loading and executing a computer program in accordance with one embodiment. As used herein, the term “computer program” refers to a sequence or list of related computer executable instructions and, where appropriate, associated data. The computing system 100 includes a number of system components. Included in the system components are a primary processor 102, a data transfer processor 104, a data storage device 106, a primary memory 108, and a system bus 110 operably connecting each of the system components. Additionally, the computing system 100 includes a non-volatile memory 112 operably connected to or contained within the primary processor 102.

As shown in FIG. 1, the non-volatile memory 112 includes a loader program 114. While the loader program 114 is shown in FIG. 1 as being stored or resident in the non-volatile memory 112, in other implementations the loader program 114 may be stored in other memory or storage devices. Furthermore, in other implementations, the loader program may be initially stored in other memory or storage devices and later loaded into the primary memory 108 for execution.

In this exemplary implementation, the primary processor 102 is configured to access and execute computer executable instructions, such as instructions of a computer program (“program”). Additionally, when appropriate, the primary processor 102 is configured to access data associated with a program. More particularly, the primary processor 102 is configured to access and execute instructions/data of programs stored in either the primary memory 108 or the non-volatile memory 112. For example, and without limitation, the primary processor 102 may be configured to access and execute instructions of the loader program 114, an operating system program, application programs, and any other number of programs stored in the primary memory 108 or the non-volatile memory 112. Furthermore, the primary processor 102 may also be configured to access and/or execute various instructions and/or data stored in other memory or storage devices.

In this exemplary implementation, the data transfer processor 104 is operable to transfer or copy blocks of information from the data storage device 106 to the primary memory 108. More particularly, the data transfer module 104 is operable to transfer blocks of a program from the data storage device 106 to the primary memory 108 for access and/or execution by the primary processor 102. The precise size or format of the blocks of the program transferred by the data transfer processor may dependent on, among other things, the manner or format in which the program is stored in the data storage device 106, the size or capacity of the bus 110, the particular configuration or implementation of the data transfer module 104, or the transfer instructions received by the data transfer module 104. In one implementation, the data transfer processor 104 is a specifically configured controller that is designed for transferring or copying blocks of information. One such type of controller is a Direct Memory Access (DMA) controller.

The data storage device 106 functions to store programs and other data in a persistent, non-volatile manner. The data storage device 106 may comprise any number or types of non-volatile or persistent data storage devices. For example, and without limitation, the data storage device 106 may be a disc drive, a floppy disk, an optical drive, flash memory, or any other various type of non-volatile memory.

The primary memory 108 provides temporary storage for programs and data being accessed by the primary processor 102. The primary memory 108 may comprise various types of memory that can be quickly written to and read from by the primary processor 102. For example, and without limitation, the primary memory may comprise various types of Random Access Memory (RAM).

As noted, the loader program 114 may be stored in either the non-volatile memory 112 or in the primary memory 108 and is executed by the primary processor 102. In this implementation the loader program 114 directs the primary processor 102, which in turn may direct the data transfer processor 104, in transferring blocks of a program into the primary memory 108 from the data storage 106. Additionally, the loader program 114 may handle or supervise execution of a program by the primary processing module 102 while the program is being loaded into the primary memory 108. For example, the loader program 114 may function to assure that the primary processor 102 does not attempt to execute program instructions that have not yet been loaded into the primary memory 108.

In accordance with one implementation, the loader program 114 is stored in the non-volatile memory 112 and executed by the primary processor 102 without the use or assistance of an operating system. For example, the loader program 114 may function to load an operating system into primary memory 108. Alternatively, for programs and/or environments where the primary processor 102 does not require an operating system, the loader program 114 may function as a loader program for a single program. In accordance with either of these examples, the loader program 114 may include, or its operations may be preceded by, other operations or programs, such as a Power-On Self Test (POST) routine, a bootstrapping routine, or other diagnostic operation, or the like. In another implementation, the loader program 114 may function as a portion of an operating system, or as a routine that is called by an operating system that is executed by the primary processor 102.

Having described various features of the computing system 100, a generalized description of various operations that may be performed in or by the computing system 100 in carrying out the concurrent loading and execution of a program will now be described. This exemplary description assumes that that any appropriate diagnostic or initialization operations required by the primary processor 102 have been previously carried out and that the loader program 114 is present in primary memory 108 or non-volatile memory 112 and is being executed by the primary processor 102.

A computer program (“the target program”) is initially stored in the data storage device 106. When it is desired for the target program to be executed by the primary processor 102, a first block of the target program is transferred from the data storage device to the primary memory 108. As used herein, the “first block” of the target program is that block of the target program, irrespective of location in memory, which includes the entry point or first instruction of the program. This first block of the target program may be transferred from data storage 106 to the primary memory 108 either using the primary processing module 102 or the data transfer processor 104.

Once this first block of the target program has been loaded into primary memory 108, two operations or processes may then be commenced substantially simultaneously. First, the primary processor 102 may begin accessing the target program from primary memory 108 and executing the target program at the entry point of the target program. Concurrently therewith, the data transfer processor 104 may begin loading the remaining blocks of the target program from the data storage device 106 to primary memory 108, as instructed by the primary processor 102.

It should be understood that the use herein of the term “concurrent” does not necessarily mean that the primary processor 102 and the data transfer processor 104 are accessing the primary memory 108 or the bus 110 at identical times. Rather, as used herein, the term concurrent specifies or indicates that the execution of portions of the target program by the primary processor 102 and the execution of the program loading operation by the data transfer processor 104 are each occurring within a given time frame. For example, it may be said that the primary processing module 102 is executing portions of the target program concurrently with the execution of the program loading operation if the portions of the target program are executed by the primary processing module 102 before the data transfer processor 104 has completed the entire program loading operation. In this example, the time required for the data transfer processor 104 to complete the loading of the portions or blocks of the target program specified by the load command is the given time frame. During this given time frame, the primary processing module 102 and the data transfer processor 104 may be accessing the primary memory module 108 or the bus 110 at different times.

As will be appreciated, once the primary processor 102 begins execution of the target program, there is some likelihood that the primary processor 102 will attempt to read an instruction of the target program that has not yet been loaded into primary memory 108. In such a situation, the following actions are taken. First, upon detection that the primary processor 102 is attempting to read a given instruction that has not yet been properly loaded into primary memory 108, execution of the target program by the primary processor 102 is halted. Next, actions are taken to assure that the given instruction is properly loaded into primary memory 108. In one embodiment, the detection that the given instruction has not yet been properly loaded into primary memory, the halting of the primary processor, and/or the actions are taken to assure that the given instruction is properly loaded into primary memory 108 may be controlled or initiated by the loader program 114.

To assure that the given instruction is properly loaded into primary memory 108, at least one of two actions may be taken. First, the continued execution of the program by the primary processor 102 may simply be delayed until the data transfer processor 104 has loaded the given instruction into primary memory 108. Alternatively, affirmative action may be taken to load the given instruction into primary memory 108. In one such affirmative implementation, the primary processor 102 may handle the transfer of the given instruction from data storage 106 to primary memory 108. In another implementation, the data transfer processor 104 may handle the transfer of the given instruction from data storage 106 to primary memory 108.

In addition to controlling or initiating those actions so far described, the loader program 114 may also perform various other operational duties. For example, upon instructing the primary processor 102 to halt execution of the program, the loader program 114 may perform or initiate a context save operation in the primary processor 102, before assuring that the given instruction is properly loaded into primary memory 108. Following the proper loading of the given instruction into primary memory 108, and before instructing the primary processor 102 to continue execution of the program, the loader program 114 may perform or initiate a context restore operation in the primary processor 102.

Another operational duty that may be performed by the loader program 114 is that of causing or instructing the data transfer processor 104 to cease loading the remaining blocks of the program from data storage 106 to primary memory 108, when it is determined by the loader program 114 that the normal execution of the program by the primary processor 102 has completed.

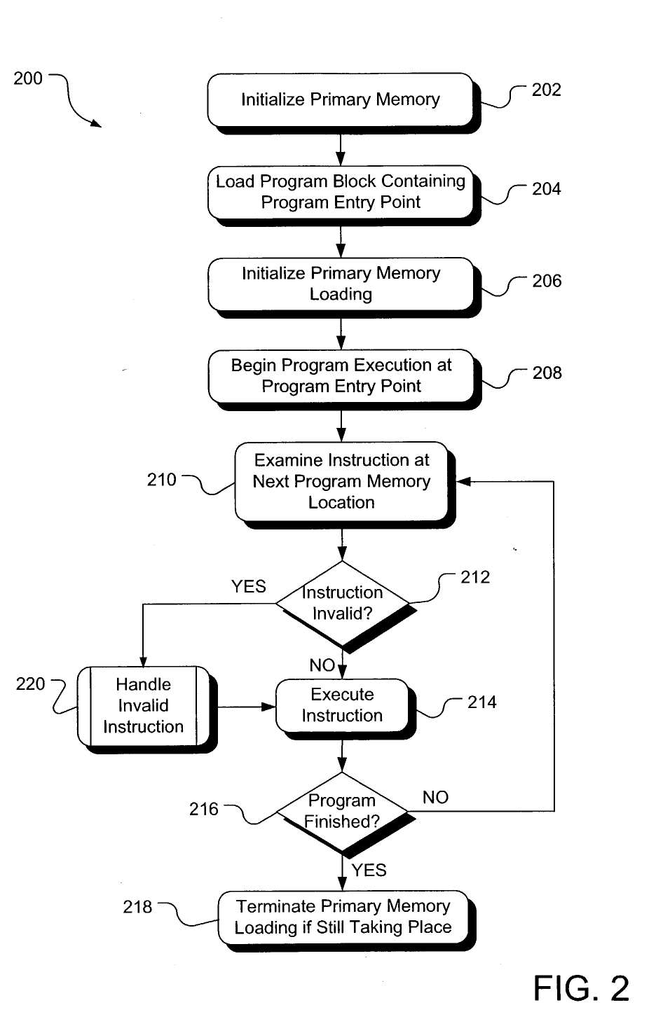

Having fully described an exemplary implementation of a system for concurrently loading and executing a program, exemplary implementations of methods that may be used in concurrently loading and executing a program will now be described. FIGS. 2, 3, and 4 illustrate exemplary operational flows including various logical operations for concurrently loading and executing a program (“the target program”). The logical operations illustrated in FIGS. 2, 3, and 4 are described particularly as being implemented by, or in conjunction with, various components of the computer system 100 shown in FIG. 1. However, it should be understood that performance of the various logical operations illustrated in FIGS. 2, 3, and 4 are not necessarily limited to one such specific implementation. Rather, the logical operations may generally be described as being implemented (1) as a sequence of computer implemented steps or program modules stored on a computer readable medium and running on a computing system and/or (2) as interconnected machine logic circuits or circuit modules within the computing system. The implementation is a matter of choice dependent on the performance requirements of the computing system in which the operations are being implemented. As used herein, computer readable medium may be any available medium that can store or embody computer-readable instructions.

As shown in FIG. 2, at the start of operational flow 200 an initialize primary memory operation 202 performs various actions that prepare the primary memory 108 for storage of the target program therein. Included in these actions may be the allocation and/or assignment of a sufficient range or set of addresses in the primary memory 108 for the target program. Additionally, the initialize primary memory operation 202 may allocate particular areas of the allocated primary memory for storage of instructions and other areas of the allocated primary memory for storage of data. As will be appreciated by those skilled in the art, the memory requirements of a given program can typically be determined from information within the program itself, such as in a header file of the program.

The initialize primary memory operation 202 may also load all or a portion of the primary memory with predetermined invalid instructions. As will be described in detail below, these invalid instructions may be used later in the operational flow 200 to indicate when the primary processor 102 is attempting to access areas of the primary memory that have not yet been loaded with instructions from the target program.

Next, a load entry point operation 204 copies a predetermined portion or block of the target program from the data storage device 106 to the primary memory 108, wherein the predetermined portion includes the program entry point. As will be appreciated by those skilled in the art, the block or portion of the program that includes the program entry point can typically be determined from information within the program itself, such as in a header portion of the program. As will also be appreciated, the size of the portion or block of the target program that is copied into primary memory 108 may vary depending on the composition of the target program, the format of the data storage device 106, the requirements or capabilities of the processor that is transferring the portion or block, the size of the bus 110, and/or the protocol that is being used to transfer the portion or block.

In one implementation, the load entry point operation 204 is carried out by the primary processor 102. That is, the primary processor controls the transfer, over the bus 110, of the block of the target program containing the program entry point from the data storage device 106 to the primary memory 108. In another implementation, the data transfer processor 104 may carry out the transfer, over the bus 110, of the block of the target program. In one implementation, the primary processor 102 issue a transfer instruction instructing the data transfer processor 104 to transfer the block of the target program containing the program entry point from the data storage device 106 to the primary memory 108. In accordance with one implementation, the transfer instruction indicates or specifies the addresses or ranges of addresses in the data storage device 106 that contain the desired block of the target program, as well as the addresses or ranges of addresses in the primary memory 108 into which the desired block of the target program is to be copied or transferred by the data transfer processor 104. It should be understood that the load entry point operation 204 is carried out before execution of the target program commences. That is, the loading of the block containing the entry point is not carried out concurrently with the execution of the target program.

As shown in FIG. 2, following the load entry point operation 204, an initialize primary memory loading operation 206 is carried out. In accordance with the initialize primary memory loading operation 206, a transfer instruction is sent from the primary processor 102 to the data transfer processor 104 instructing the data transfer processor 104 to transfer the remaining blocks of the target program from the data storage device 106 to the primary memory 108. That is, the transfer instruction instructs the data transfer processor 104 to transfer that portion of the target program that was not transferred to the primary memory 108 during the load program entry point operation 204. As previously described, the transfer instruction may include information indicating the addresses or range of addresses of the in the data storage device 106 that contain the remaining blocks of the target program, as well as the addresses or ranges of addresses in the primary memory 108 into which the remaining blocks of the target program are to be copied or transferred by the data transfer processor 104.

Following the initialize primary memory loading operation 206, a begin program execution operation 208 is carried out in which the primary processor 102 begins execution of the target program from the primary memory 108. It should be understood that while the begin program execution operation 208 is shown in FIG. 2 as occurring following the initialize primary memory loading operation 206, the begin program execution operation 208 may be carried prior to the initialize primary memory loading operation 206. Furthermore, the begin program execution operation 208 and the initialize primary memory loading operation 206 may carried out substantially concurrently.

At this point in the operational flow 200, the target program is being executed by the primary processor 102 at substantially the same time as the remaining portions of the target program are being loaded into the primary memory 108 by the data transfer processor 104. As the target program is being executed, the primary processor 102 will be accessing data and instructions at various locations or addresses in the primary memory 108. As will be appreciated, instructions in a program will not typically be executed by a processor in a linear manner according to the addresses of the instructions in memory. Rather, a processor will typically access and execute instructions from a number of noncontiguous addresses in memory. As such, it is conceivable that in executing the target program, the primary processor 102 may be directed or vectored to an address in the primary memory 108 that has not yet been loaded with the proper instruction of the target program. To ensure that the primary processor 102 will not attempt to execute an instruction at a given address in primary memory that has not yet been loaded, the operational flow 200 includes various operations (210, 212, 214, 216, and 220) that ensure that the proper instruction is loaded at the given address prior the primary processor 102 attempting to execute an instruction at the given address.

Following the memory loading operation 206 and the begin program execution operation 208 an examination operation 210 examines the next memory location or address that is to be accessed by the primary processor 102. That is, the examination operation 210 accesses the memory location for the next instruction to be executed by the primary processor 102. The memory location for the next instruction to be executed may be determined in a number of ways. For example, the memory location may be determined by examining a program counter register, or the like, in the primary processor 102.

Next, an invalid instruction determination operation 212 determines if the memory location examined in the examination operation 210 contains an invalid instruction. As used herein, the term invalid instruction may be defined as either an instruction that is not executable by the processor and/or a predefined trappable instruction that causes an exception to occur in the primary processor 102. Conversely, a valid instruction may be defined as an instruction that is executable by the processor and that is not a predefined trappable instruction that causes an exception to occur in the primary processor 102.

The manner in which the invalid instruction determination operation 212 determines if the instruction is invalid may vary. For example, if during the initialize primary memory operation 202 the examination operation 210 loaded the memory location examined in the examination operation 210 with an invalid instruction, and if the data transfer processor 104 has not yet loaded the memory location with a valid instruction, the invalid instruction may be detected by an invalid instruction trap mechanism in the primary processor 102. In other implementation, the manner in which the invalid instruction determination operation 212 determines if the instruction is invalid may differ, depending on the particular capabilities of the primary processor, or whether a particular task or routine is used to make this determination. It should be understood that rather than detecting whether the instruction is invalid, the determination operation 212 may determine if the instruction at the memory location examined in the examination operation 210 is valid. In such a case, the locations of operations 214 and 220 following the determination operation 212 in the operational flow 200 would of course be reversed for positive and negative determinations.

If it is determined in the invalid instruction determination operation 212 that the memory location examined does not contain an invalid instruction, the instruction is executed at the execute instruction operation 214 by the primary processor. Following the execute instruction operation 214, a program finished determination operation 216 determines whether execution of the target program has been completed. If it is determined at the program finished determination operation 216 that the execution of the target program has been completed, a termination operation terminates the loading of the target program by the data transfer processor 104, if the target program is still being loaded. If it is determined at determination operation 216 that the execution of the target program has not been completed, the operational flow returns to the examination operation 210.

Returning to the prior discussion of the invalid instruction determination operation 212, if it is determined in the determination operation 212 that the memory location examined in the examination operation 210 contains an invalid instruction, a handle invalid instruction operation 220 assures that appropriate instruction is loaded into the memory location examined in the examination operation 210, before the operational flow proceeds to the execute instruction operation 214. In one implementation, if it is determined in the determination operation 212 that the memory location examined in the examination operation 210 contains an invalid instruction, an interrupt occurs. This interrupt, in turn, triggers the handle invalid instruction operation 220.

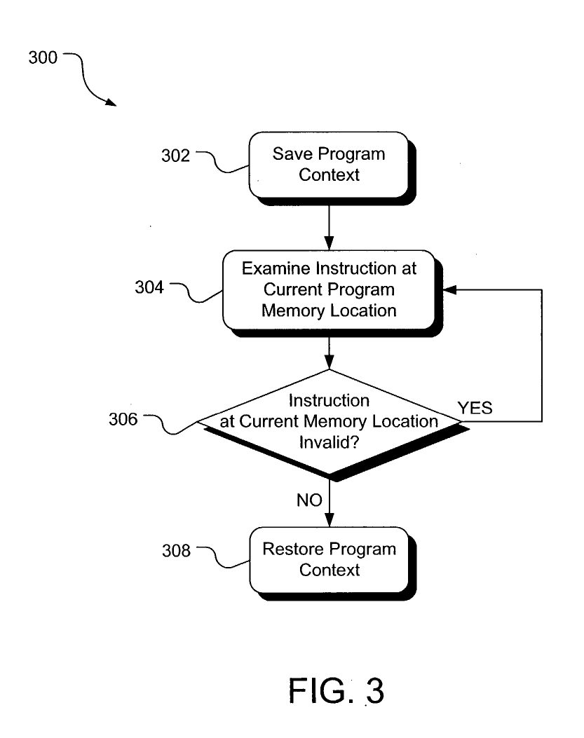

FIG. 3 illustrates an exemplary operational flow 300 including various operations that may be performed in accordance with a first implementation of the handle invalid instruction operation 220. As shown in FIG. 3, at the beginning of the operational flow 300 a context save operation 302 is performed. That is, the “context” within which the target program is executing is saved to memory. The context of a target program is the state of the primary processor 102 at a particular moment of time in which the target program is executing. The context may include register values associated with the target program when the target program is interrupted. In other implementations, context may be defined to include other values as well.

Following the context save operation 302, an examine instruction operation 304 examines the instruction at the current program memory location. In one implementation, the examine instruction operation 304 examines the information present at the location pointed to by a program counter in the primary processor 102. Next, an invalid instruction determination operation 308 determines if the instruction at the current program memory location is invalid. As with the invalid instruction determination operation 212 described above, the manner in which the invalid instruction determination operation 308 determines if the instruction is invalid may vary. For example, if during the initialize primary memory operation 202 the examination operation 210 loaded the current program memory location with an invalid instruction, and if the data transfer processor 104 has not yet loaded the current program memory location with a valid instruction, the invalid instruction will be detected. In other implementation, the manner in which the invalid instruction determination operation 308 determines if the instruction is valid may differ, depending on the particular capabilities of the primary processor, or whether a particular task or routine is used to make this determination. Again, it should be understood that rather than detecting whether the instruction is invalid, invalid instruction determination operation 308 may determine if the instruction at the current memory location is valid. In such a case, the operations 304 and 308 following invalid instruction determination operation 308 in the operational flow 300 would of course be reversed for positive and negative determinations.

If it is determined by the invalid instruction determination operation 308 that the instruction at the current program memory location is invalid, the operational flow 300 returns to the examine instruction operation 304. If, however, it is determined by the invalid instruction determination operation 308 that the instruction at the current program memory location is not invalid, a restore context operation 308 is performed, and the handle invalid instruction operation 220 ends. That is, the context of the target program that was saved to memory in the context save operation 302 is restored and the operational flow 200 proceeds to the execute instruction operation 214. The operational flow 200 then proceeds on as previously described until completion of the operational flow 200. As will be appreciated, operations 304 and 306 form an operational loop that is not exited until it is determined that a non-trappable instruction is present at the current program memory location.

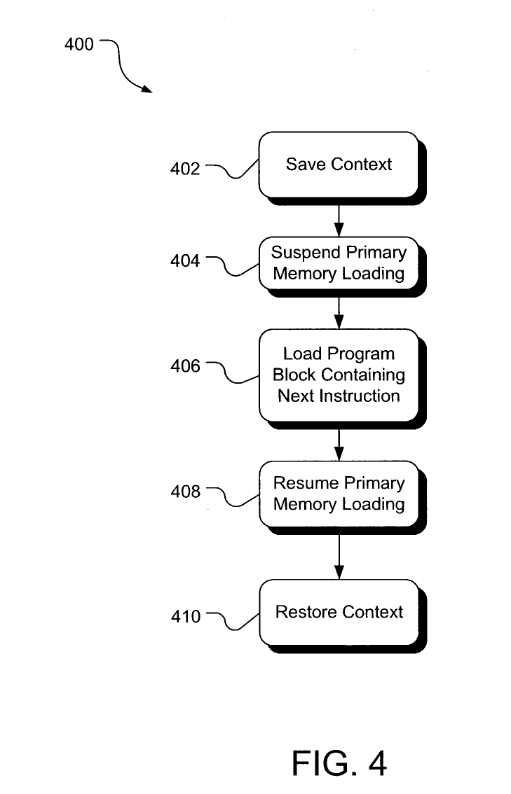

FIG. 4 illustrates an exemplary operational flow 400 including various operations that may be performed in accordance with a second implementation of the handle invalid instruction operation 220. As shown in FIG. 4, at the beginning of the operational flow 400 a context save operation 402 is performed. Following the context save operation 402, a suspend operation 404 suspends the current loading of the primary memory. In accordance with one implementation, the suspend operation suspend operation 404 suspends the loading of the primary memory by sending an instruction to the data transfer processor 104 instructing the data transfer processor 104 to suspend the loading of the primary memory.

Next, a load program block operation 406 loads the target program block that includes the next instruction to be executed into the primary memory. The manner in which the load program block operation 406 loads the target program block into primary memory may vary. For example, in accordance with one implementation, an instruction may be sent to the data transfer processor 104 to transfer or copy the target program block from the data storage device 106 to the primary memory 108. In another implementation, the primary processor may be instructed to transfer or copy the target program block from the data storage device 106 to the primary memory 108.

Following the load program block operation 406, a resume primary memory loading operation 408 resumes the loading of the primary memory 108. In accordance with one implementation, the resume primary memory loading operation 408 resumes the loading of the primary memory by sending a signal to the data transfer processor 104 instructing the data transfer processor 104 to resume loading of the primary memory.

Following the resume primary memory loading operation 408, a restore context operation 410 is performed, and the handle invalid instruction operation 220 ends. That is, the context of the target program that was saved to memory in the context save operation 402 is restored and the operational flow 200 proceeds to the execute instruction operation 214. The operational flow 200 then proceeds on as previously described until completion of the operational flow 200.

In accordance with one implementation, the suspension and resumption of the loading of the primary memory is not performed in the second implementation of the handle invalid instruction operation 220. That is, in accordance with one implementation, the operational flow 400 does not include operations 404 and 408.

The preceding description set forth various implementations of systems and methods for concurrently loading and executing software programs. The implementations described incorporate various elements and/or steps recited in the appended claims. The implementations are described with specificity in order to meet statutory requirements. However, the description itself is not intended to limit the scope of this patent. Rather, the inventor has contemplated that the claimed invention might also be implemented in other ways, to include different elements/steps or combinations of elements/steps similar to the ones described in this document, in conjunction with other present or future technologies.

1. A method comprising:
initiating copying of a portion of a computer program to a specified set of addresses in a memory; and
before the portion has been entirely copied to the specified set of addresses,
executing an invalid instruction handling routine in response to detection of an invalid instruction at a given address in the specified set of addresses; and
loading a valid instruction at the given address after detection of the invalid instruction.

2. A method as defined in claim 1, further comprising executing the valid instruction at the given address after execution of the invalid instruction handling routine has completed.

3. A method as defined in claim 2, wherein copying the portion of the computer program to the specified set of addresses in the memory is carried out by a first processor.

4. A method as defined in claim 3, wherein executing the valid instruction at the given address is carried out by a second processor.

5. A method as defined in claim 4, wherein loading the valid instruction at the given address is carried out by the first processor.

6. A method as defined in claim 4, wherein loading the valid instruction at the given address is carried out by the second processor.

7. A method as defined in claim 4, wherein the first processor comprises a Direct Memory Access (DMA) controller.

8. A method as defined in claim 4, wherein prior to initiating copying of the portion of the computer program to the specified set of addresses in the memory invalid instructions are written to each of the addresses in the specified set of addresses.

9. A method as defined in claim 8, wherein the invalid instruction handling routine controls the loading of the valid instruction at the given address.

10. A method as defined in claim 9, wherein the invalid instruction handling routine is carried out by the second processor.

11. A method as defined in claim 4, wherein the invalid instruction handling routine instructs the second processor to perform the following operations:
saving context of the second processor; and
restoring context of the second processor in response to the loading of the valid instruction at the given address.

12. A method as defined in claim 11, wherein the loading of the valid instruction at the given address is performed by the first processor.

13. A method as defined in claim 11, wherein the loading of the valid instruction at the given address is performed by the second processor.

14. A method as defined in claim 4, wherein the invalid instruction handling routine instructs the second processor to perform the following operations:
saving context of the second processor;
signaling the first processor to suspend copying the portion of the computer program to the specified set of addresses in the memory;
loading of the valid instruction at the given address;
signaling the first processor to resume copying the portion of the computer program to the specified set of addresses in the memory; and
restoring context of the second processor.

15. A method as defined in claim 1, wherein initiating copying of the portion of the computer program to the specified set of addresses in the memory comprises:
sending an instruction to a Direct Memory Access (DMA) controller to copy the portion of the computer program from a non-volatile memory to the specified set of addresses in the memory.

16. A method as defined in claim 15, wherein the memory comprises Random Access Memory (RAM).

17. A method as defined in claim 16, wherein prior to initiating copying invalid instructions are copied to each of the specified set of addresses in the memory.

18. A method as defined in claim 16, wherein the invalid instruction handling routine is executed by a microprocessor and wherein the microprocessor sends the instruction to the DMA controller to copy the portion of the computer program from the non-volatile memory to the specified set of addresses in the memory.

19. A system comprising:
a first processor configured to perform a write operation comprising writing a specified portion of a computer program including instructions into designated addresses of a memory; and
a second processor configured to access and execute the program instructions from the designated addresses of the memory concurrently with a performance of the write operation by the first processor.

20. A system as defined in claim 19, wherein the first processor comprises a Direct Memory Access (DMA) controller.

21. A system as defined in claim 19, wherein the second processor is further configured to suspend execution of the program instructions in response to a detection of an invalid instruction at a particular address in the designated addresses of the memory.

22. A system as defined in claim 21, wherein the second processor is further configured resume execution of the program instructions following the suspension of the execution of the program instructions in response to a detection of a valid instruction at the particular address in the designated address of the memory.

23. A system as defined in claim 22, wherein the second processor is further configured to write a valid instruction at the particular address in response to the detection of the invalid instruction at the particular address.

24. A system as defined in claim 22, wherein the second processor is further configured to instruct the first processor to write a valid instruction at the particular address in response to the detection of the invalid instruction at the particular address.

25. A system as defined in claim 21, wherein the second processor is further configured to perform a context save operation in response to the detection of the invalid instruction at the particular address and prior to suspending execution of the program instructions.

26. A system as defined in claim 19 wherein the first processor is further configured to perform the following operations in response to the detection of the invalid instruction:
performing a context save operation;
suspending execution of the program instructions;
writing a valid instruction at the particular address;
performing a context restore operation; and
continuing execution of the program instructions.

27. A system as defined in claim 19 wherein the first processor is further configured to perform the following operations in response to the detection of the invalid instruction:
performing a context save operation;
suspending execution of the program instructions;
detecting a valid instruction at the particular address;
performing a context restore operation; and
continuing execution of the program instructions.

28. A system comprising:
a primary memory;
a Direct Memory Access (DMA) controller operably connected to the primary memory; and
a microprocessor operably connected to the primary memory and the DMA controller, wherein the microprocessor is configured to,
cause the DMA controller to load a specified portion of a computer program including program instructions into designated addresses of the primary memory; and
execute the program instructions from the designated addresses of the memory concurrently with the loading by the DMA controller of the specified portion of the computer program into the designated addresses of the primary memory.

29. A system as defined in claim 28, wherein the microprocessor is further configured to execute an invalid instruction handling routine in response to detection of an invalid instruction at one of the designated addresses.

30. A system as defined in claim 29, wherein execution of the invalid instruction handling routine causes the DMA controller to suspend loading of the specified portion of the computer program into the designated addresses of the primary memory until a valid instruction is loaded into the one of the designated addresses.

31. A system as defined in claim 30, wherein execution of the invalid instruction handling routine further causes the microprocessor to load a valid instruction into the one of the designated addresses.

32. A system as defined in claim 28, wherein the microprocessor is further configured to load an initial portion of the computer program into the primary memory prior to causing the DMA controller to load the specified portion of the computer program into the designated addresses of the primary memory.

33. A system as defined in claim 32, wherein the initial portion of the computer program includes a program entry point.

34. A computer-readable medium having computer-executable instructions for performing acts comprising:
loading a computer program into a memory; and
executing instructions of the computer program concurrently with the loading of the computer program into the memory.

35. A computer-readable medium as defined in claim 34, wherein the act of loading the computer program comprises:
instructing a first processor to load a first portion of the computer program; and
instructing a second processor to load a second portion of the computer program.

36. A computer-readable medium as defined in claim 34, wherein the computer program consists of a first portion and a second portion and wherein the act of loading the computer program comprises:
instructing a first processor to load the first portion of the computer program; and
instructing a second processor to load the second portion of the computer program.

37. A computer-readable medium as defined in claim 34, further having computer-executable instructions for performing acts comprising:
executing an invalid instruction handling routine in response to the detection of an invalid instruction at a particular address in the memory.

38. A computer-readable medium as defined in claim 37, wherein the instruction handling routine comprises computer-executable instructions for performing acts comprising:
performing a context save operation;
suspending execution of the computer program;
detecting a valid instruction at the particular address in the memory;
performing a context restore operation; and
terminating the suspension of the execution of the computer program.

39. A computer-readable medium as defined in claim 37, wherein the instruction handling routine comprises computer-executable instructions for performing acts comprising:
performing a context save operation;
suspending execution of the computer program;
writing a valid instruction at the particular address;
performing a context restore operation; and
terminating the suspension of the execution of the computer program.
